(19) United States
(12) Patent Application Publication
(10) Pub. No.: US 2002/0078137 A1
(43) Pub. Date: Jun. 20, 2002

(54) Spring

(76) Inventors: Robert Olodort, Santa Monica, CA (US); John Tang, San Carlos, CA (US); Peter M. Cazalet, Campbell, CA (US)

Correspondence Address: Daniel E. Ovanezian, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/737,015

(22) Filed: Dec. 14, 2000

(51) Int. Cl. G06F 15/16; G06F 15/177

(52) U.S. Cl. 709/203; 709/220

(57) ABSTRACT

A network-based method for configuring disconnect switches includes receiving disconnect switch specification information from a user and using a server to compare the received specification information with pre-stored information. The method also includes selecting at least one disconnect switch that matches the received specification information and displaying to the user information related to the disconnect switch. A network-based method also provides for selection of various accessories for the selected disconnect switch.

### BACKGROUND OF THE INVENTION

This invention relates generally to computer network-based systems and more particularly to a network-based method and system for configuring disconnect switches.

Disconnect switches are used in electric equipment and machinery, but identifying a correct disconnect switch for a specific application is not always an easy task. Many parameters should be considered, and each combination of parameters could demand a specific disconnect switch for optimum performance.

Therefore, it would be desirable to quickly determine a proper disconnect switch that should be used for different combinations of parameters. In addition, it would be desirable to determine if a particular disconnect switch provides inadequate performance for equipment, machinery, or a facility.

### BRIEF SUMMARY OF THE INVENTION

In an exemplary embodiment, a disconnect switch selection system allows users to select the most appropriate disconnect switch for their application needs over the Internet. In one embodiment the disconnect switch selection system is used for selection of ML disconnect switches. In another embodiment, the disconnect switch selection system is used for selection of FD1 disconnect switches The system guides a web user to answer several pre-arranged questions interactively about the product attributes and then uses those inputs to direct the user to a uniquely configured product having a specific catalog number. If the user's input combination results in an invalid configuration, the user receives messaging to guide the user to a valid alternative. The system allows both experienced and novice users to place orders directly for disconnect switches through the use of the Internet.

The network-based method for selecting a correct disconnect switch includes receiving product specification information from a user and comparing the received product specification information with pre-stored disconnect switch information. If at least one disconnect switch matches the received user criteria for the disconnect switch, the pre-stored disconnect switch information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for configuring disconnect switches;

FIG. 4 is an exemplary embodiment of a ML Disconnect Switch Needs Assessment page that includes a plurality of links to be used when supplying information to the system shown in FIG. 3;

FIG. 5 is an exemplary embodiment of a ML Disconnect Switch Features page;

FIG. 6 is an exemplary embodiment of a ML Disconnect Switch Accessories page;

FIG. 7 is an exemplary embodiment of a ML Disconnect Switch Exception Message Page;

FIG. 8 is an exemplary embodiment of an FD1 Disconnect Switch Needs Assessment page;

FIG. 9 is an exemplary embodiment of an FD1 Disconnect Switch Features page;

FIG. 10 is an exemplary embodiment of an FD1 Disconnect Switch Accessories page;

FIG. 11 is an exemplary embodiment of an FD1 Disconnect Switch Exception Message page; and

FIG. 12 is an exemplary embodiment of a Bill of Material page.

### DETAILED DESCRIPTION OF THE INVENTION

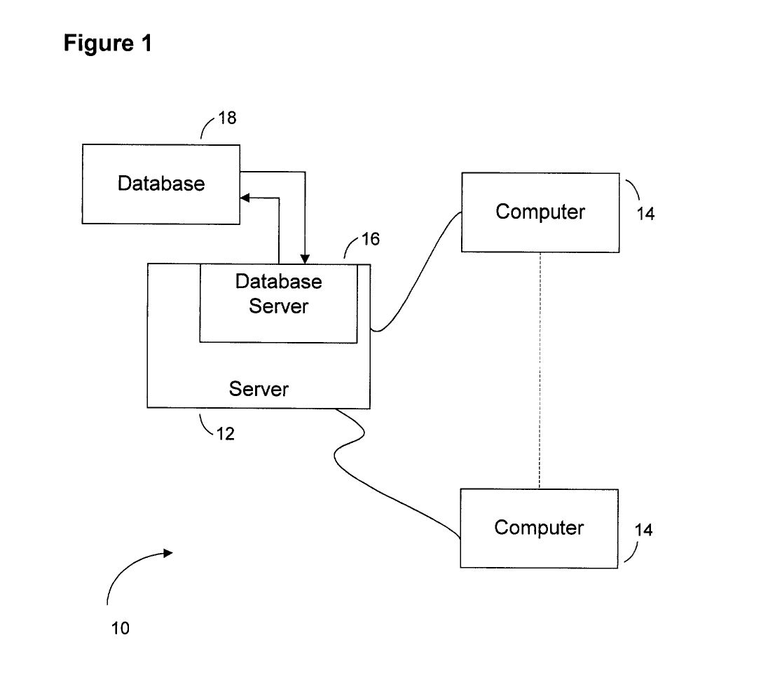

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing disconnect switch information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

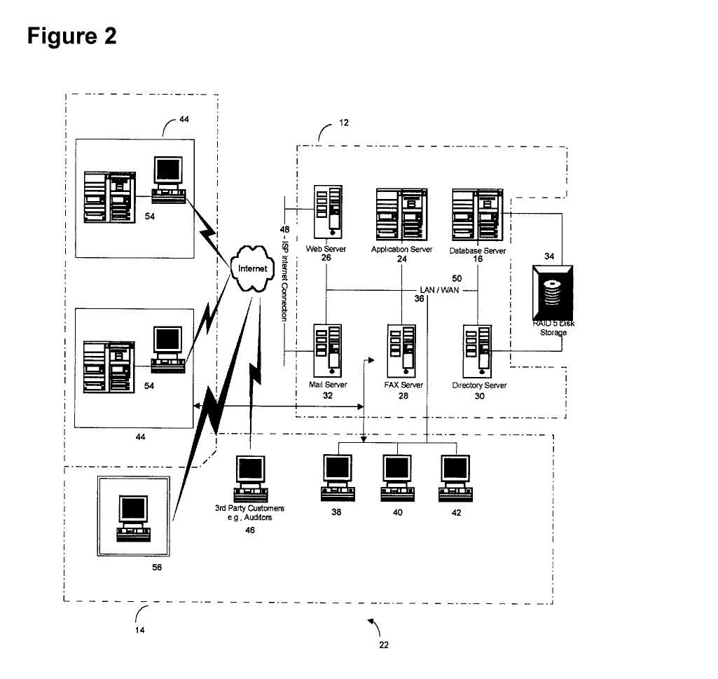

FIG. 2 is an expanded version block diagram of an exemplary embodiment of a server architecture of a system 22. System 22 includes server subsystem 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 54 can access server sub-system 12. One of user devices 14 includes a workstation 54 located at a remote location. Workstations 54 are personal computers having a web browser. Also, workstations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

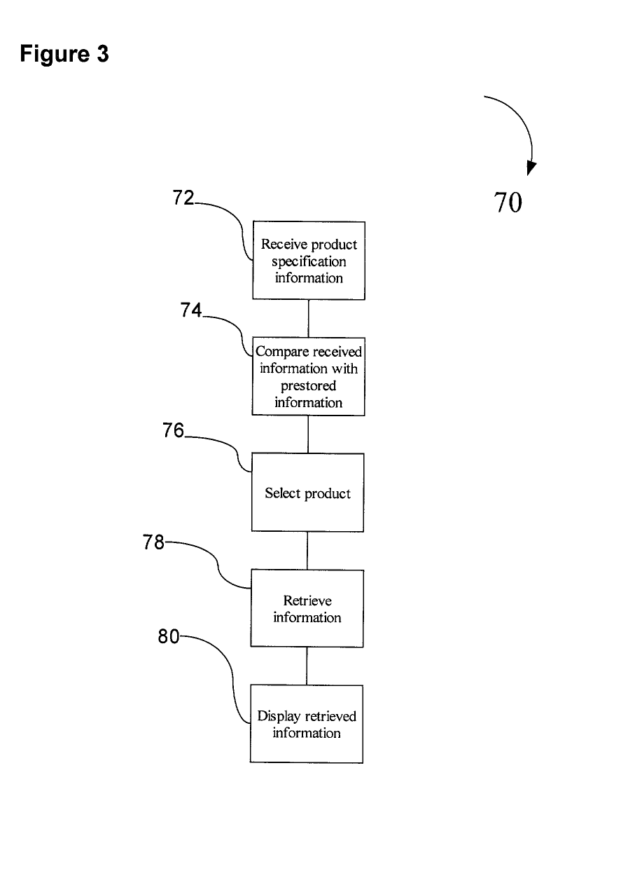

FIG. 3 is a flow diagram 70 for a network-based method for configuring disconnect switches. In one embodiment, the disconnect switch selection involves selection of disconnect switches. System 10 (shown in FIG. 1) receives 72 product specification information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 74 the received disconnect switch related requirements to pre-stored information accessible by server 12. In one embodiment, the pre-stored information is stored in a database that resides on server 12. In an alternative embodiment, the pre-stored information is stored in a database remote from server 12. The pre-stored information includes various types and configurations of disconnect switch related information. Server 12 compares the user provided information to the pre-stored information to determine if any pre-stored disconnect switch information contained in the database satisfy the product specifications/requirements submitted by the user.

In addition, server system 12 assesses the information supplied by the user to validate configuration compatibility of the product. Exemplary information includes product application, product parameters, desired product features, and product accessories. System 10 evaluates the information supplied by the user and determines whether a resulting product incorporating a disconnect switch having the received product specifications is capable of meeting parameters of the indicated product. For example, system 10 determines whether a selected disconnect switch with a given requirement is available to satisfy the user, and, if the selected disconnect switch with a given requirement is not available, system 10 displays a message to the user that the disconnect switch with the required product characteristics is not available and that the user should select an alternative product. In summary, system 10 reviews the user input and based on a pre-determined disconnect switch configuration as well as operating specifications, the user is provided feedback for a specific disconnect switch that meets the criteria for the user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored disconnect switch information that matches the information entered by the user and selects 76 disconnect switch configurations from the pre-stored information. System 10 retrieves 78 information pertaining to the selected disconnect switch configuration. In one embodiment, the disconnect switch information includes a disconnect switch identifier number and associated price for each selected disconnect switch configuration. For example, the disconnect switch identifier number is a catalog number and the price is a list price of the product. Server 12 then transmits the retrieved identifier number and associated price and downloads the retrieved disconnect switch information to user device 14 for display 80 so that the user can view the information. In an alternative embodiment, system 10 uses the list price information to generate a quotation for each selected disconnect switch configuration including the indicated features and accessories and server 12 then transmits the retrieved disconnect switch identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against predetermined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

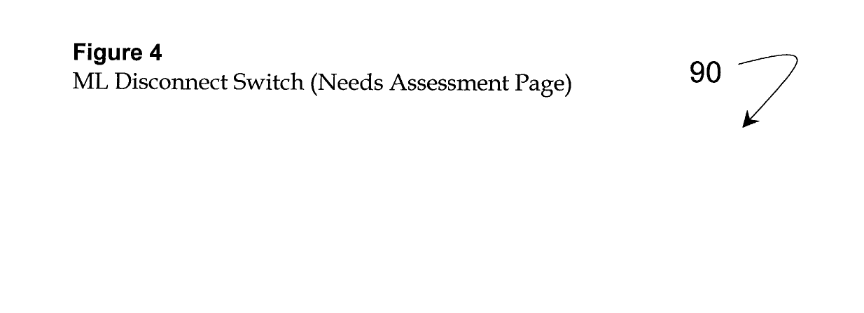

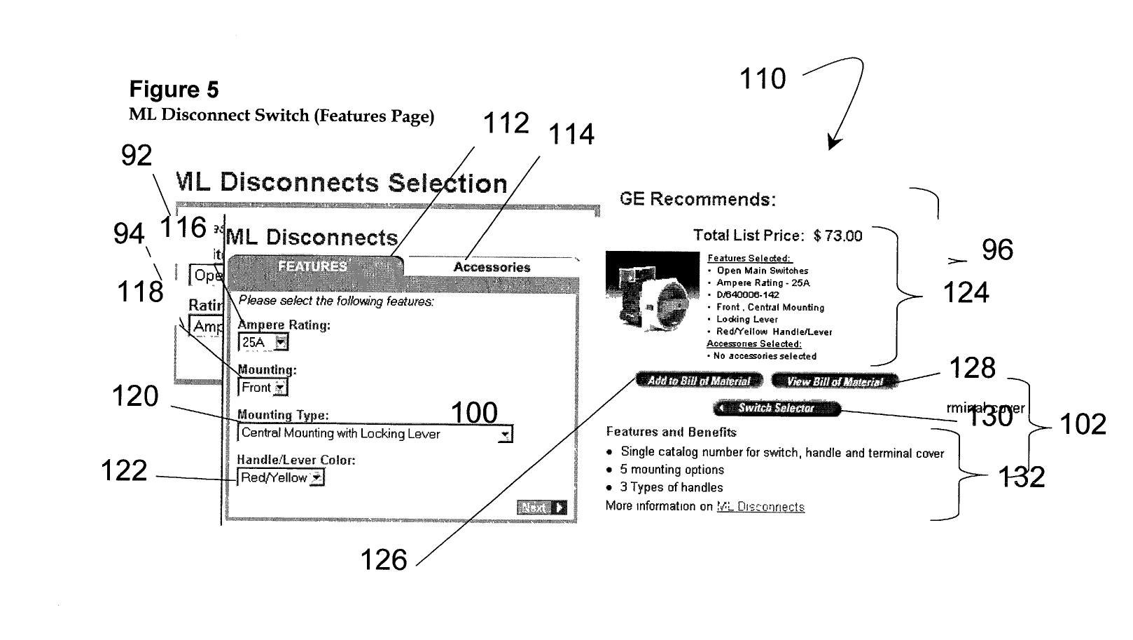

FIG. 4 shows an exemplary embodiment of a ML Disconnects Switch Needs Assessment page, as depicted in screen shot 90. Screen shot 90 includes a Switch Type pull down menu 92, a Rating Type pull down menu 94, and a recommendation area 96. Screen shot 90 also includes a Continue button 100, and a Features and Benefits display area 102. Selection of Continue button 100 causes system 10 (shown in FIG. 1) to display FIG. 5, discussed below.

FIG. 5 shows an exemplary embodiment of a ML Disconnect Switch Features page, as depicted in screen shot 110. Screen shot 110 includes a Features tab 112 and an Accessories tab 114. Screen shot 110 results from selection of Features tab 112, and includes an Ampere Rating pull down menu 116, a Mounting pull down menu 118, a Mounting Type pull down menu 120, and a Handle/Lever Color pull down menu 122. Screen shot 110 also includes a recommendation display area 124 that displays information about a recommended disconnect switch, including in one embodiment a list price. Screen shot 110 further includes an Add to Bill of Material button 126, a View Bill of Material button 128, and a Switch Selector button 130, as well as a Features and Benefits display area 132. Add to Bill of Material button 126 adds the selected item to the bill of material. View Bill of Material button 128 causes system 10 (shown in FIG. 1) to display a Bill of Material page, discussed below. Switch Selector button 130 takes the user to the ML Disconnects Selection page, shown in FIG. 4.

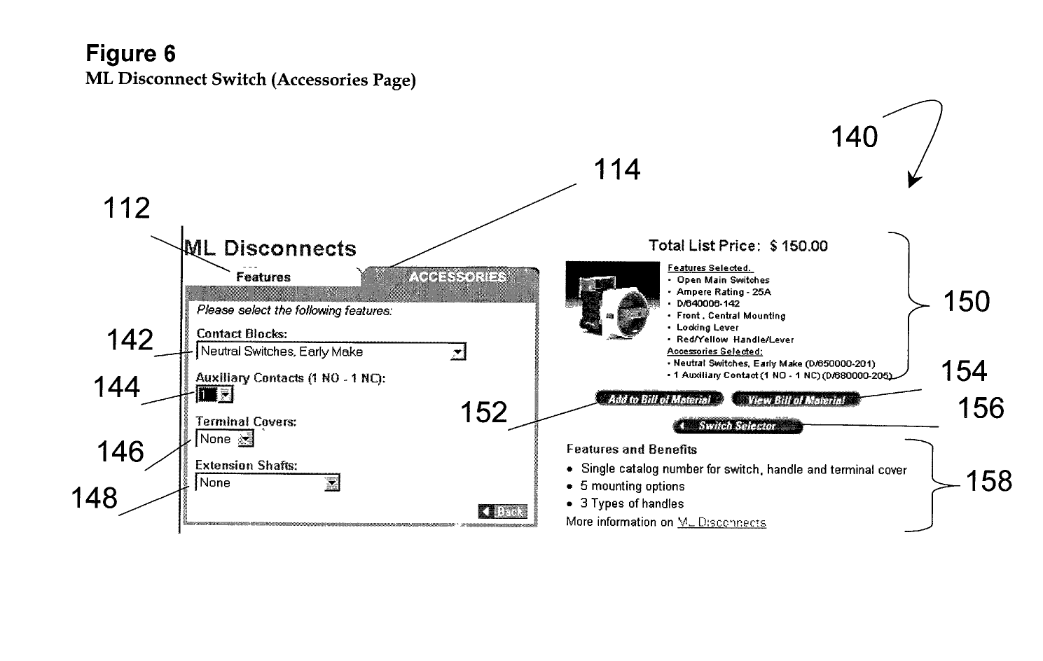

FIG. 6 shows an exemplary embodiment of a ML Disconnect Switch Accessories page, as depicted in screen shot 140. Screen shot 140 results from selection of Accessories tab 114 shown in FIG. 5, and includes a Contact Blocks pull down menu 142, an Auxiliary Contacts (1 NO - 1 NC) pull down menu 144, a Terminal Covers pull down menu 146, and an Extension Shafts pull down menu 148. Screen shot 140 also includes a recommendation area 150, that in one embodiment includes a list price, an Add to Bill of Material button 152, a View Bill of Material button 154, and a Switch Selector button 156. Screen shot 140 also includes a Features and Benefits display area 158.

Add to Bill of Material button 152 adds the selected item to the bill of material. View Bill of Material button 154 causes system 10 (shown in FIG. 1) to display a Bill of Material page, discussed below. Switch Selector button 156 takes the user to the ML Disconnects Selection page, shown in FIG. 4.

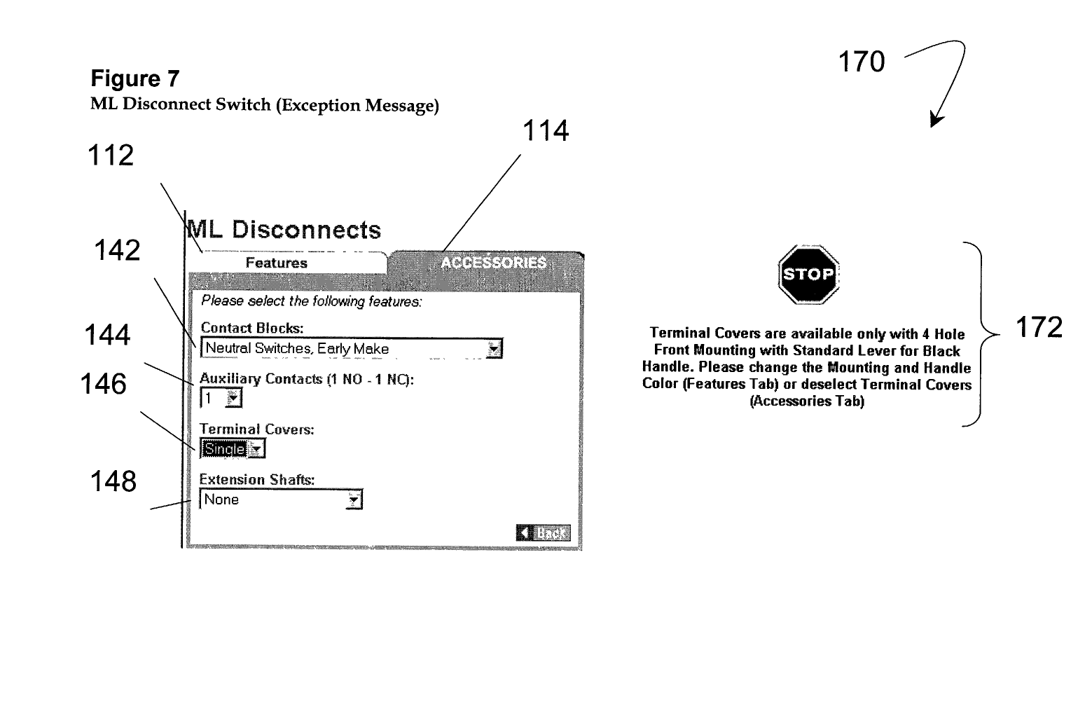

FIG. 7 shows an exemplary embodiment of a ML Disconnect Switch Exception Message page, as depicted in screen shot 170. Screen shot 170 includes an exception message area 172, that informs the user that the selections made are not mutually compatible, and how at least one selection can be changed to remove the incompatibility.

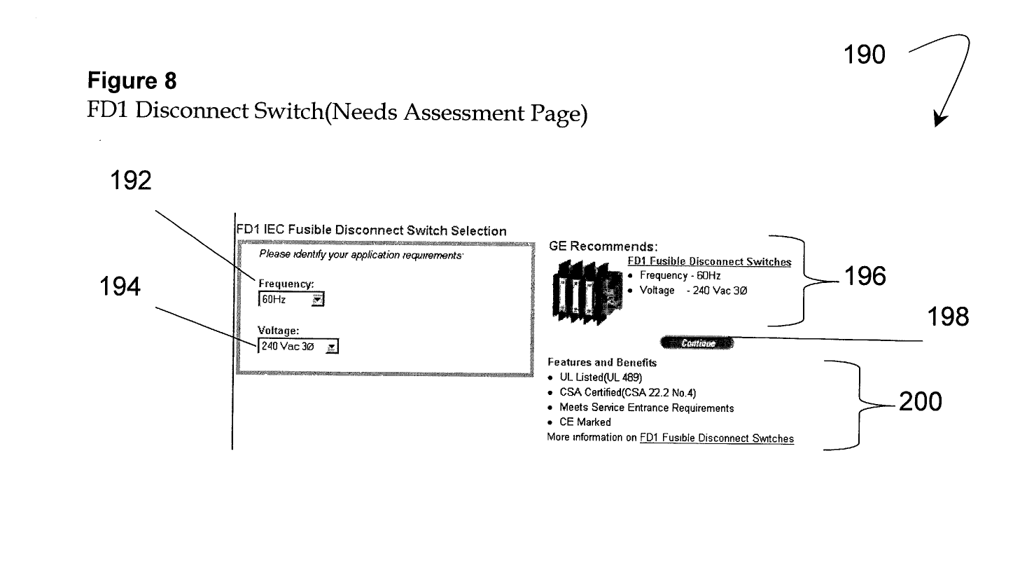

FIG. 8 shows an exemplary embodiment of an FD1 Disconnect Switch Needs Assessment page, as depicted in screen shot 190. Screen shot 190 includes a Frequency pull down menu 192, and a Voltage pull down menu 194. Screen shot 190 also includes a recommendation area 196 that specifies further information about the recommended product, and a Continue button 198. Screen shot 190 also includes a Features and Benefits display area 200. Selection of Continue button 198 causes system 10 (shown in FIG. 1) to display FIG. 5, discussed below.

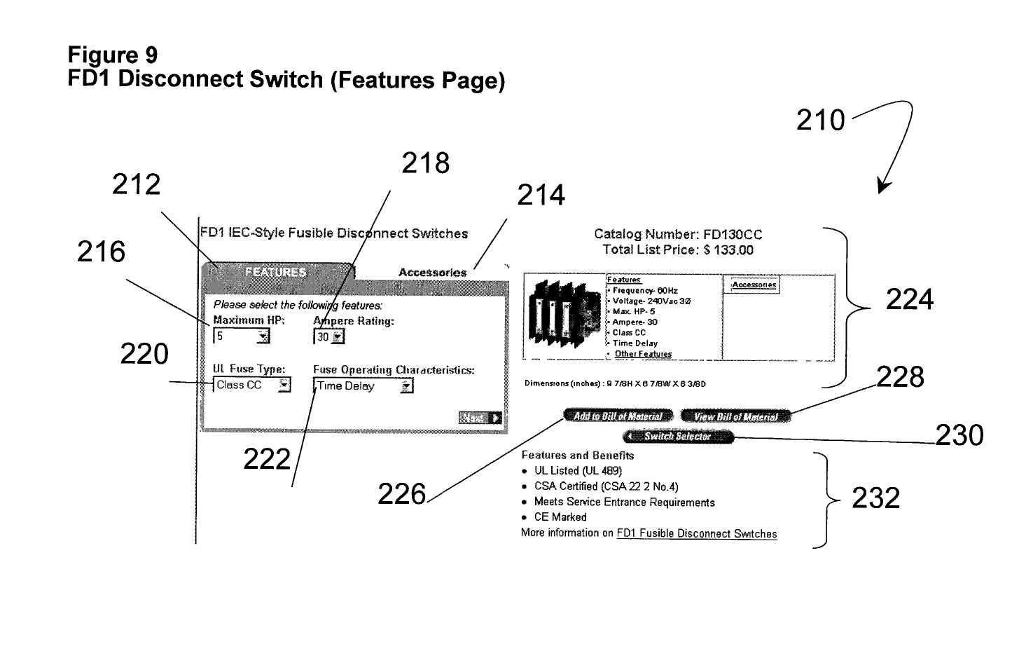

FIG. 9 shows an exemplary embodiment of an FD1 Disconnect Switch Features page, as depicted screen shot 210. Screen shot 210 includes a Features tab 212 and an Accessories tab 214. Screen shot 210 results from selection of Features tab 212, and includes a Maximum HP pull down menu 216, and Ampere Rating pull down menu 218, a UL Fuse Type pull down menu 220, and a Fuse Operating Characteristics pull down menu 222. Screen shot 210 also includes a recommendation area 224 that in one embodiment includes a catalog number and a list price. Screen shot 210 further includes an Add to Bill of Material button 226, a View Bill of Material button 228, and a Switch Selector button 230. Screen shot 210 still further includes a Features and Benefits display area 232.

Add to Bill of Material button 226 adds the selected item to the bill of material. View Bill of Material button 228 causes system 10 (shown in FIG. 1) to display a Bill of Material page, discussed below. Switch Selector button 230 takes the user to the FD1 Disconnects Selection page, shown in FIG. 8.

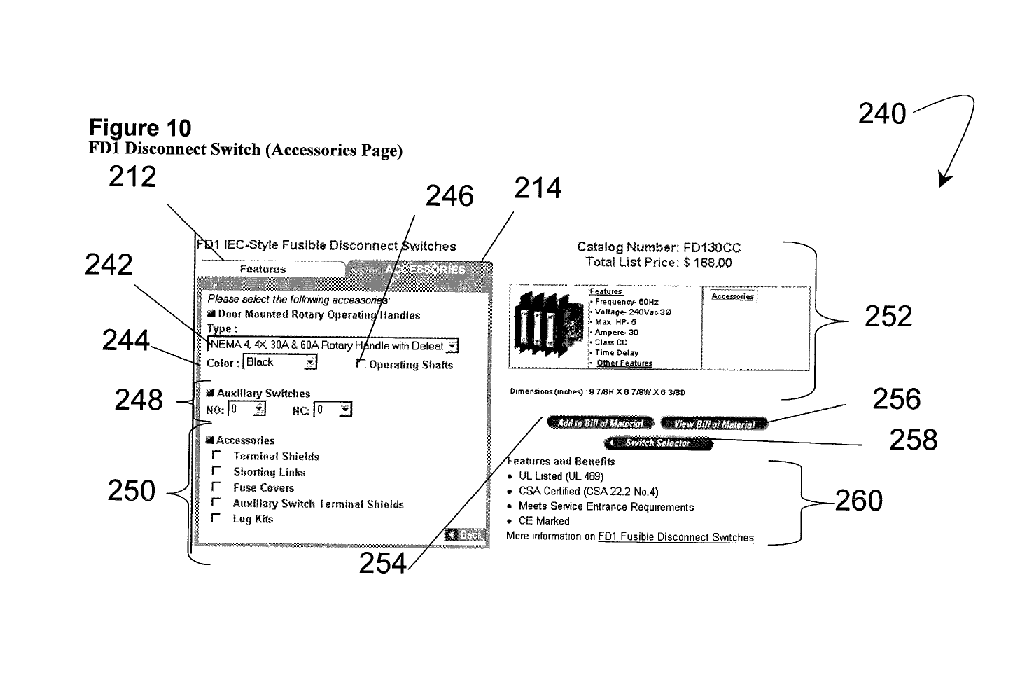

FIG. 10 is an exemplary embodiment of an FD1 Disconnect Switch Accessories page, as depicted in screen shot 240, which results from selection of Accessories tab 214. Screen shot 240 includes a Door Mounted Operating Handles Type pull down menu 242, a Color pull down menu 244, an Operating Shafts check box 246, a set of Auxiliary Switches pull down menus 248, and a set of Accessories check boxes 250. Screen shot 240 also includes a recommendations area 252 that in one embodiment includes a catalog number and a list price, an Add to Bill of Material button 254, a View Bill of Material button 256, and a Switch Selector button 258. Screen shot 240 also includes a Features and Benefits display area 260.

Add to Bill of Material button 254 adds the selected item to the bill of material. View Bill of Material button 256 causes system 10 (shown in FIG. 1) to display a Bill of Material page, discussed below. Switch Selector button 258 takes the user to the FD1 Disconnects Selection page, shown in FIG. 8.

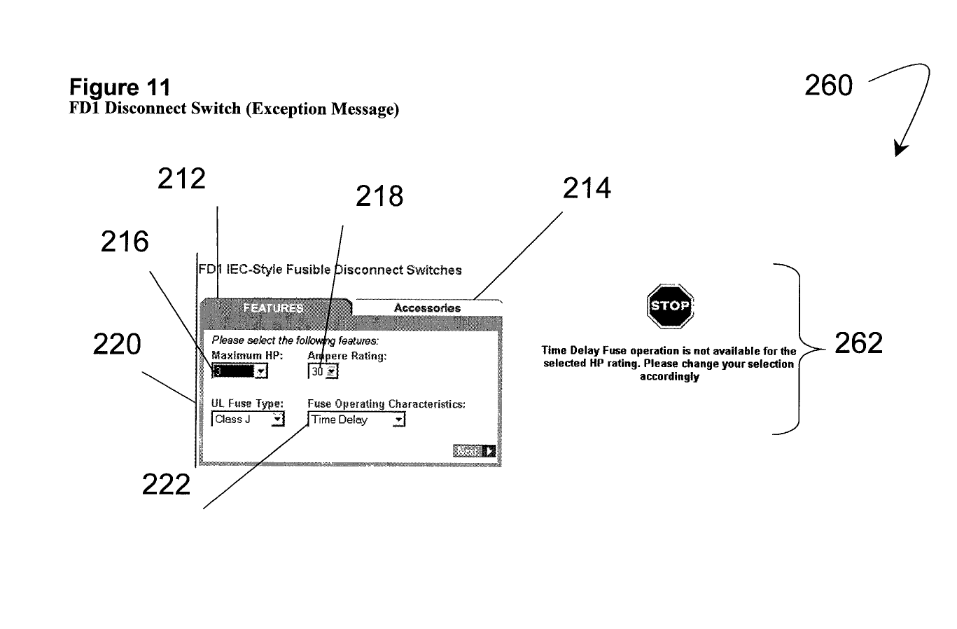

FIG. 11 is an exemplary embodiment of an FD1 Disconnect Switch Exception Message page, as depicted in screen shot 260. Screen shot 260 includes an exception message area 262 that informs the user that the selections made are not mutually compatible, and that at least one of the selections made should be changed.

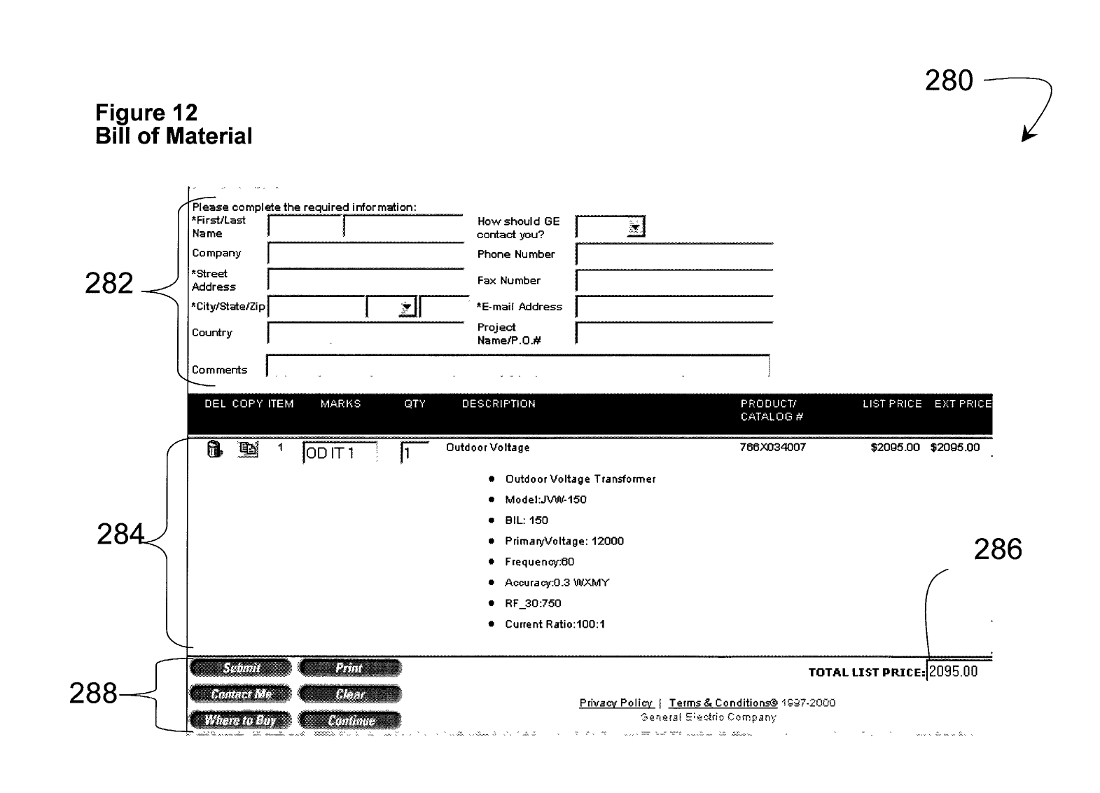

FIG. 12 is an exemplary embodiment of a Bill of Material page, as depicted in screen shot 280, that is downloaded and displayed by server system 12 when the user has selected “View Bill of Material” button 128 (shown in FIG. 5). Screen shot 280 includes a customer information area 282 where a user can specify contact information. Screen shot 280 also includes an order area 284 to display information about the order, including in one embodiment a specification of an item ordered, the quantity, description, catalog number, and price. Screen shot 280 further includes a List Price text box 286 that displays a total price of all items ordered. Screen shot 280 still further includes a set of buttons 288 that allow the user to submit the order, print the order, clear the bill of material, request that the user be contacted, find out where to buy the product, or continue.

In use, system 10 (shown in FIG. 1) provides the user with a complete disconnect switch configured to meet the user's needs. The user selects the properties of the disconnect switch, including switch type, rating type, mounting, mounting type, contact blocks, auxiliary contacts, terminal covers, extension shafts, frequency, voltage, maximum horsepower, fuse type, fuse operating characteristics, and any optional features. Based on these inputs system 10 displays the individual equipment prices and the total list price of the individual components. System 10 does not allow the user to configure a selection that is invalid and guides the user by informing the user why the selected configuration is invalid. Once the customer has configured the product, the user can add it to the user's bill of materials and then view the bill of materials, which the user can optionally print, or submit as an order.

While the invention has been described in terms of various specific embodiments, those skilled in the art will recognize that the invention can be practiced with modification within the spirit and scope of the claims.

What is claimed is:

1. A method for facilitating selection of an disconnect switch through use of a network-based system including a server and at least one device connected to the server via a network, said method comprising the steps of:
receiving product specification information from a user via the device;
comparing the received product specification information with prestored disconnect switch information;
selecting at least one disconnect switch that matches the received product specification information; and
displaying the information related to the disconnect switch.

2. A method according to claim 1 wherein said step of comparing the received product specification information comprises the steps of:
determining whether the features selected are available for the selected disconnect switch configuration; and
displaying a message if the selected features are not available for the selected disconnect switch configuration.

3. A method according to claim 1 wherein said step of receiving product information data from a user further comprises the step of receiving an identification for the product.

4. A method according to claim 1 wherein said step of displaying information related to the disconnect switch comprises the step of displaying the features selected for the disconnect switch.

5. A method according to claim 1 wherein said step of displaying information related to the disconnect switch comprises the step of displaying the accessories selected for the disconnect switch.

6. A method according to claim 1 wherein said step of displaying information related to the disconnect switch comprises the step of displaying a catalog number and a list price for the disconnect switch.

7. A method according to claim 1 wherein said step of displaying information further comprises the step of generating a quotation for the disconnect switch.

8. A method according to claim 1 wherein said step of displaying information related to the disconnect switch comprises the step of displaying the dimensions of the disconnect switch.

9. A method according to claim 1 wherein the product specification information is received from the user via a graphical user interface.

10. A method according to claim 1 further comprising the step of assessing a need of the user based on at least one of a product application, product parameters, desired product features, and product accessories.

11. A method according to claim 1 further comprising the step of validating configuration compatibility based on the received product specification information to determine whether a resulting disconnect switch having the received product specifications is capable of meeting parameters of the product.

12. A method according to claim 14 further comprising the step of guiding the user, if the resulting product does not meet the parameters of the product, to a correct product configuration.

13. A method according to claim 11 further comprising the step of guiding the user to a compatible product.

14. A system for facilitating selection of a disconnect switch, said system comprising:
a device; and
a server connected to said device and configured to receive product specification information data from a user via said device, said server further configured to:
compare the received product specification information with pre-stored disconnect switch information;
select at least one disconnect switch from the pre-stored disconnect switch information based on disconnect switch identification criteria entered by the user; and
display information related to the disconnect switch based on the disconnect switch identification criteria.

15. A system according to claim 14 wherein said server further configured to download to the user the information related to the disconnect switch.

16. A system according to claim 14 wherein said server further configured to:
determine whether the features selected are available for the selected disconnect switch configuration; and
display a message if the selected features are not available for the selected disconnect switch configuration.

17. A system according to claim 14 wherein said server further configured to receive an identification for the product.

18. A system according to claim 14 wherein said server further configured to display the dimensions of the disconnect switch.

19. A system according to claim 14 wherein said server further configured to display the accessories selected for the disconnect switch.

20. A system according to claim 14 wherein said server further configured to:
determine whether the features selected are available for the selected disconnect switch configuration; and
display a message if the selected features are not available for the selected disconnect switch configuration.

21. A system according to claim 14 wherein said server further configured to receive an identification for the product.

22. A system according to claim 14 wherein said server further configured to display the features selected for the disconnect switch.

23. A system according to claim 14 wherein said server further configured to display the dimensions of the disconnect switch.

24. A system according to claim 14 wherein said server further configured to display the accessories selected for the disconnect switch.

25. A system according to claim 14 wherein said server further configured to display a catalog number and a list price for the disconnect switch.

26. A system according to claim 14 wherein said server further configured to generate a quotation for the disconnect switch.

27. A system according to claim 14 wherein said server further configured to receive the product specification information from the user via a graphical user interface.

28. A system according to claim 14 wherein said server further configured to assess a need of the user based on at least one of a product application, product parameters, desired product features, and product accessories.

29. A system according to claim 28 wherein said server further configured to validate configuration compatibility based on the received product specification information to determine whether a resulting disconnect switch having the received product specifications is capable of meeting parameters of the product.

30. A system according to claim 29 wherein said server further configured to guide the user, if the resulting product does not meet the parameters of the product, to a correct product configuration.

31. A system according to claim 30 wherein said server further configured to guide the user to a compatible product.

32. A system according to claim 14 wherein said server further configured to accept a purchase order for the disconnect switch after the purchase order has been authenticated against pre-determined criteria.

33. A system according to claim 14 wherein said device configured to be a server for a network of customer devices.

34. A system according to claim 14 wherein said server and said device are connected via a network.

35. A system according to claim 34 wherein said network is one of a wide area network, a local area network and the Internet.
